(19) United States
(12) Patent Application Publication
(10) Pub. No.: US 2008/0276188 A1
(43) Pub. Date: Nov. 6, 2008

(54) METHOD OF DISTRIBUTED STORYTELLING

(76) Inventor: Michael Zerger, Trophy Club, TX (US)

Correspondence Address: Michael A. O'Neil;Michael A. O'Neil, P.C., Suite 820, 5949 Sherry Lane, Dallas, TX, 75225, US

(21) Appl. No.: 11/970,174

(22) Filed: Jan. 7, 2008

Related U.S. Application Data
(60) Provisional application No. 60/915,816, filed on May 3, 2007.

(51) Int. Cl. G06F 3/048

(52) U.S. Cl. 715/764

(57) ABSTRACT

A method for distributing a story in a non-linear format comprises providing a story in multiple plot segments through multiple publication sources. An initial plot segment is provided by an author comprising at least one clue for directing a reader to additional plot segments. The additional segments may comprise clues for directing the reader to yet additional segments and eventually a final plot segment providing a resolution to the story.

### CROSS-REFERENCE TO RELATED APPLICATION

This application claims priority based on provisional patent application Ser. No. 60/915,816 filed May 3, 2007, the entire content of which is incorporated herein by reference.

### TECHNICAL FIELD

This invention relates generally to a method of telling stories, and more particularly to a method for telling stories in a distributed, non-linear format.

### BACKGROUND AND SUMMARY OF THE INVENTION

Traditional methods for telling a story have presented the story in a linear format, telling the story from beginning no end in sequential order. Typically a complete story is provided in a single book, in volumes of books, in a series of articles in periodicals, and in various other published works provided to the public. All that a person wanting to read or near the story need do is purchase the printed or electronic media through which the story is presented, with no further interaction required other than to read or listen to the story.

Serialization of books was pioneered by Charles Dickens and more recently practiced by Adam Bellow, with his practice of “pamphleteering” laying out a story in a linear end to end format in a series of pamphlets. Although linear storytelling is the traditional manner in which stories are presented, non-linear storytelling has been practiced by authors including Samuel R. Delany and James Joyce, both of whom have used magical realism in their storytelling, fragmenting the narration to resemble real world interactive storytelling. Although fragmented narration provides a more real world approach to storytelling, the stories are still presented in a linear format in a single work or series of works.

Traditional storytelling has generally required a substantial commitment of both time and financial resources by an author, requiring the author to complete and edit a work before releasing the story to publication. The published work will either succeed or fail without the author having a chance to revise the story to accommodate public opinion and/or contributions regarding plot lines and/or characters of the story. An author may get a second chance with a second or follow-up story, but if the previous attempt failed and was not accepted by readers, the readers are less likely to purchase or read a subsequent story or series of stories.

The present invention comprises a method for distributing stories in a non-linear, distributed format which overcomes the foregoing difficulties that have long since characterized the prior art. In accordance with the broader aspects of the invention a method for distributing a story comprises providing a story in multiple plot segments through multiple publication sources.

In accordance with the more specific aspects of the invention an initial plot segment is provided by at least one author in a first publication source and comprises at least one clue for a reader to locate and access additional plot segments. The additional plot segments may be released non-sequentially and across multiple publication sources. Each additional plot segment may comprise one or more clues to lead the reader to yet other plot segments and ultimately to a plot resolution or final plot segment. Each story may comprise multiple plot lines enabling a reader to experience multiple stories from the initial plot segment. The reader must actively engage the provided plot segments and provided clues in order to continue and complete each story.

Stories may be provided by multiple authors collaborating across multiple publication sources. By distributing stories according to the method of the present invention an author need not create an entire story before publishing part of the story to the public. The author may adjust future plot segments and clues according to reader feedback, collaborative input from other authors, editorial comment, and the like. Because a traditional book publication is not required to release stories or a series of stories, authors will no longer be confined by fiscal and time constraints to produce an entire book for publication.

### BRIEF DESCRIPTION OF THE DRAWINGS

A more complete understanding of the present invention may be had by reference to the following Detailed Description when taken in connection with the accompanying Drawing, wherein:

FIG. 1 is a flowchart illustrating the method of the present invention.

### DETAILED DESCRIPTION

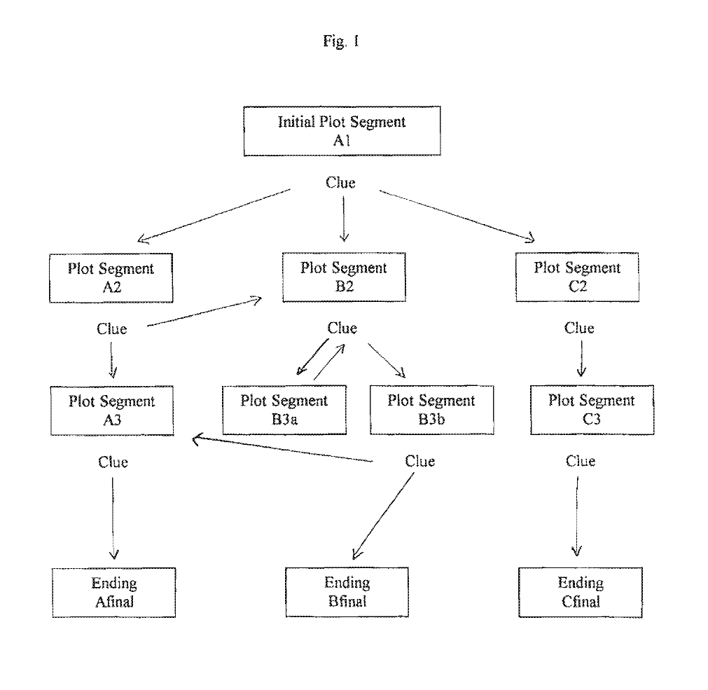

Referring now to FIG. 1 there is shown an example of a story provided by an author according to a method for distributing a story in a non-linear format comprising the present invention. The story is presented in multiple segments through one or more publication sources beginning with providing an initial plot segment A1 through a first source A. The initial plot segment includes at least one clue to a reader for finding and accessing more plot segments for the story.

A next level of plot segments may be provided for the reader in multiple pieces A2, B2, and C2 through various sources, such as second source B, third source C, and again through first source A. These plot segments may or may not have clues leading to yet another level of plot segments A3, B3a, B3b, and C3. If a plot segment does not provide a clue, such as plot segment B3a, the reader may re-evaluate the previous plot segment or segments in light of the newest information gained. The reader may then discover another clue leading to yet another plot segment or a different series of plot segments. The foregoing process of following clues to access additional plot segments to the story continues until the reader eventually finds at least one ending or resolution to the story such as Afinal, Bfinal, or Cfinal.

Within each story, there may be several story lines that are independent or intertwined with other plot segments such that a reader may follow one story line through one series of plot segments and come to a different ending and resolution as compared with another reader that followed a different series of plot segments. In order to obtain the entire story, a reader must actively engage each plot segment and the provided clues to complete the story. For example, the reader may begin by following the clue given by the initial plot segment A1 to plot segment B2 and then follows through to B3, etc. to come to ending Bfinal. Alternatively, another reader may follow the clue from A1 to plot segment A2, A3, etc. and ending with Afinal, or the same reader may follow all of the clues to all of the plot segments thereby reading multiple stories from one initial plot segment.

The plot segments and clues may or may not be published concurrently with the initial plot segment, depending on the publication sources chosen to provide the plot segments. For example, the initial plot segment may be presented in a daily newspaper publication with the clue indicating that the next level of plot segments are available on a specified website, in a the next issue of the newspaper, an upcoming magazine, or any number of printed publication sources. The reader may also need to engage the use of authentic public informational websites such as Wikipedia® and the like and search engines such as Google® and the like to research certain details needed for the story. For example, if the story is a murder mystery, the reader may need to investigate certain types of weapons based on information provided in the story segments to determine which weapon was used in order to solve part of the mystery.

In addition to authentic news and information sources the author may create and provide links to sources created for the story such as an online newspaper such as “www.thelocalpaper.com”, for example, a created law enforcement website such as “www.policeblotter.com”, for example. In addition to printed and electronic publication sources for accessing story segments the author may provide spoiler publications for a reader that chooses not to actively pursue the story further or may get caught on a particular clue and cannot continue without assistance. As a result of seeking plot information and clues for a story from various sources at various times, the reader may ultimately create a unique story not intended or anticipated by the author. Likewise, a reader may begin with a plot segment previously read and explored, but may explore different clues and plot segments resulting in a completely different story than discovered in previous attempts. Sources may include entries in existing or fabricated social networking sites such as MySpace® or Facebook® and may include personal sites and blogs.

The method for distributing a story of the present invention may further comprise providing multiple authors collaborating on a story or series of stories such as an adventure series, mystery series, and the like. By providing multiple authors collaborating in the method of the present invention, the story or series of stories created may comprise a broader, more diverse storyline and thereby appeal to a broader audience than stories written by a single author presented sequentially through a traditional book-based publication. The present invention may further comprise a step enabling readers to contribute characters and story segments to the story, thus creating an even more diverse story than may be created by a single author.

Although preferred embodiments of the invention nave been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method for telling a story comprising the steps of:
utilizing at least one selected publication source to provide an initial plot segment;
providing at least one clue in conjunction with the initial plot segment for directing a reader to additional plot segments;
utilizing a plurality of selected publication sources to provide a plurality of additional plot segments;
providing a plurality of clues in conjunction with the plurality of additional plot segments for directing the reader to additional plot segments;
providing at least one final plot segment comprising a resolution to the story; and
providing at least one clue within each additional plot segment for directing the reader to the at least one final plot segment.

2. The method according to claim 1 wherein the additional plot segments are provided through publication sources other than the selected publication source.

3. The method according to claim 1, wherein the selected publication source is a printed publication.

4. The method according to claim 1 wherein the selected publication source is an internet publication.

5. The method according to claim 1 comprising the additional step of providing a reader interface for receiving feedback from readers regarding additional plot segments.

6. The method according to claim comprising the additional step of providing a spoiler source for a reader unable to access the additional plot segments from the provided clues.
